(19) United States
(12) Patent Application Publication
(10) Pub. No.: US 2011/0134037 A1
(43) Pub. Date: Jun. 9, 2011

(54) MOUSE

(75) Inventor: Tsung-Shih Lee, Taipei (TW)

(73) Assignee: Cheng Uei Precision Industry Co., Ltd, Taipei (TW)

(21) Appl. No.: 12/634,186

(22) Filed: Dec. 9, 2009

(51) Int. Cl. G06F 3/033

(52) U.S. Cl. 345/163

(57) ABSTRACT

A mouse includes a bottom casing and a top casing coupled with the bottom casing to receive a PCB and a roller unit therebetween. The PCB defines an opening penetrating a front side thereof to form two opposite side edges and a rear edge connected to the two side edges. The PCB further has at least three switches two of which respectively located near the two side edges of the opening and the other one located near the rear edge of the opening. The roller unit includes a roller bearing which has a pair of press wings extended outwardly from two opposite lateral sides thereof for corresponding to the two switches located near the two side edges of the opening, and a projection protruded from a bottom of a rear thereof for corresponding to the switch located near the rear edge of the opening.

### BACKGROUND OF THE INVENTION

1. Field of the Invention

The present invention relates to an input device, and more particularly to a mouse.

2. The Related Art

As is known to all, mouse is a very popular computer input device, it allows a user to move an input pointer (e.g., cursor) and to make selections with respect to a graphical user interface (GUI). With the rapid development of computer, the mouse will not be limited to the current operation functions. Mouse in the future will have multiple functions such as switch function, multi-button function, and the like. How to improve the structure of the mouse to achieve aforesaid multiple functions, it has become an urgent problem need to be resolved.

### SUMMARY OF THE INVENTION

It is an object of the present invention to provide a mouse having multi-button function. The mouse includes a bottom casing and a top casing coupled with the bottom casing to receive a printed circuit board and a roller unit therebetween. The bottom casing has a retainer plate at a front portion thereof and a backing plate in rear of the retainer plate. The retainer plate defines a location hole thereon and the backing plate defines a receiving recess thereon. The printed circuit board defines an opening penetrating a front side thereof to form two opposite side edges and a rear edge connected to the two side edges and a slit positioned in rear of the opening. The printed circuit board further has at least three switches wherein two of which respectively located near the two side edges of the opening and the other one located between the rear edge of the opening and the slit. The printed circuit is mounted on the bottom casing with backing plate passing through the slit while the retainer plate located in front of the opening. The roller unit includes a roller bearing, a roller pivotally assembled to the roller bearing, and an encoder fixed to the roller bearing and associated with the roller. The roller bearing has a location post extended forward from a front thereof to insert into the location hole of the retainer plate, and a sliding post extended rearward from a rear thereof to be received in the receiving recess of the backing plate. The roller bearing further has a pair of press wings extended outwardly from two opposite lateral sides thereof for corresponding to the two switches located near the two side edges of the opening, and a projection protruded from a bottom of the rear thereof for corresponding to the switch located between the rear edge of the opening and the slit. The top casing defines a through hole thereon for allowing the roller to partially project out therefrom.

As described above, the mouse can realize multi-button function by providing the pair of press wings for pressing against and activating the corresponding switches located near the two side edges of the opening to perform a leftward or rightward movement of a file or document or web page on display screen, and by providing the projection for pressing against and activating the corresponding switches located between the rear edge of the opening and slit to perform a middle click action.

### BRIEF DESCRIPTION OF THE DRAWINGS

The present invention will be apparent to those skilled in the art by reading the following description of an embodiment thereof, with reference to the attached drawings, in which:

FIG. 1 is a perspective view of a mouse in accordance with the present invention;

FIG. 2 is a partial perspective view of the mouse shown in FIG. 1 without top casing;

FIG. 3 is a top plan view of FIG. 2;

FIG. 4 is an exploded view of FIG. 2; and

FIG. 5 is a perspective view of a roller bearing of the mouse.

### DETAILED DESCRIPTION OF THE PREFERRED EMBODIMENT

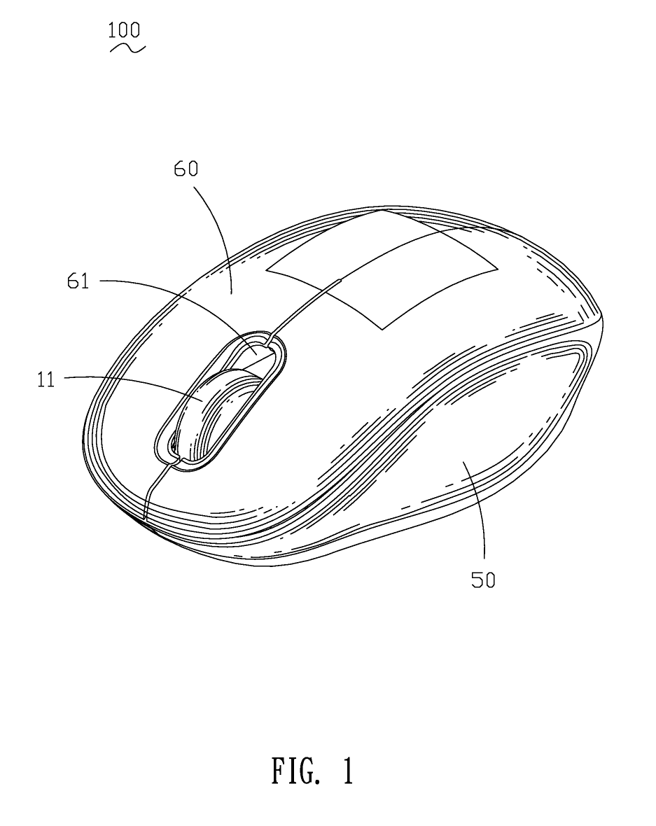

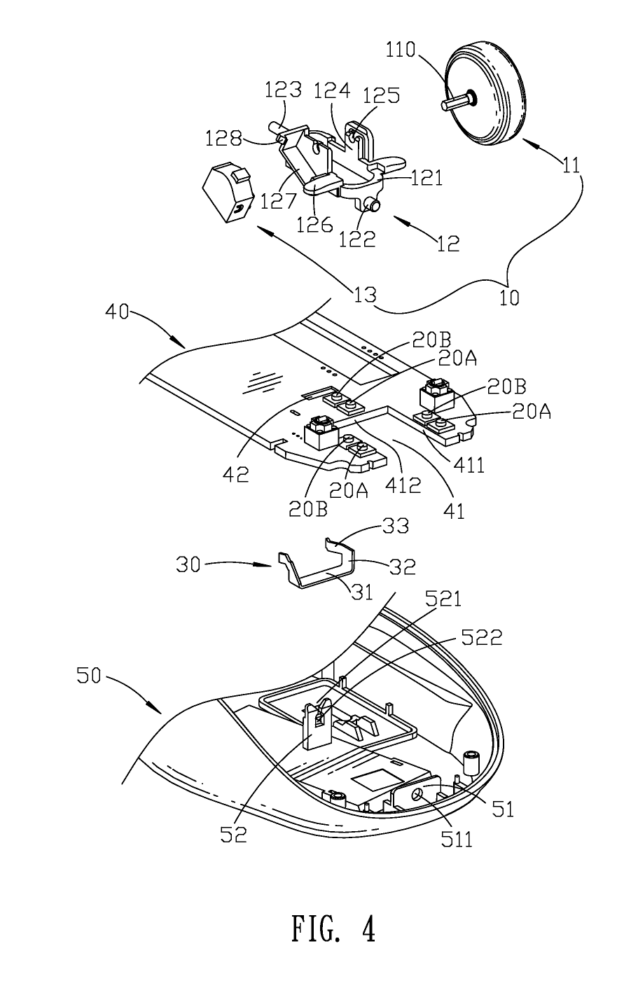

With reference to FIGS. 1 and 4, a mouse 100 according to the present invention has a mouse housing which includes a bottom casing 50 and a top casing 60 coupled with the bottom casing 50 to receive a roller unit 10, a printed circuit board (PCB) 40 with a plurality of switches 20 formed thereon, and a latch element 30 therebetween.

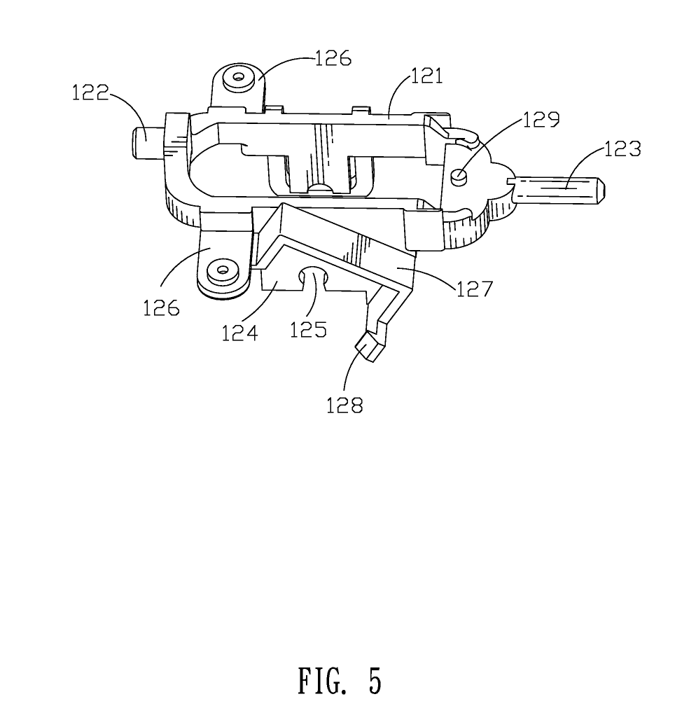

As illustrated in FIG. 4, the roller unit 10 includes a roller 11, a roller bearing 12 and an encoder 13. The roller bearing 12 has a substantially rectangular frame 121 whose front side and rear side respectively extend forward and rearward to form a location post 122 and a sliding post 123 longer than the location post 122. A pair of support plates 124 extends upwardly from the middle portions of two opposite lateral sides of the frame 121 and each defines a pivot hole 125 at a top end thereof. A pair of press wings 126 extends outwardly from front portions of the two opposite lateral sides of the frame 121 to be located in front of the support plates 124. A recessed part 127 which has a lock portion 128 at a rear thereof is provided at an outside of one support plate 124. The roller bearing 12 further forms a projection 129 (see FIG. 5) protruded from a bottom portion of the rear side of the frame 121.

In assembly of the roller unit 10, the roller 11 is pivotally assembled to the roller bearing 12 by means of an axle 110, which penetrates the axis of the roller 11, engaging with the pivot holes 125. Then the encoder 13 is received and fixed to the recessed part 127 by the lock portion 128 so as to associate with the axle 110. If a finger is rolled over the roller 11, the encoder 13 can sense and transform the rotation of the roller 11 into an upward or downward movement of a file or document or web page on a display screen.

The PCB 40 defines an opening 41 penetrating a front side thereof to form two opposite side edges 411 and a rear edge 412 connected to the two side edges 411 and a slit 42 positioned in rear of the opening 41. The plurality of switches 20 includes six switches 20 which are divided into three groups respectively located near the three edges of the opening 41. Furthermore, one group is located between the rear edge 412 of the opening 41 and the slit 42. Each of the groups includes two switches 20 arranged longitudinally to be further defined as front switch 20A and rear switch 20B for convenience.

The latch element 30 has a flat-plate base portion 31, a pair of sidewalls 32 extended upwardly from both ends of the base portion 31 and a pair of elastic arms 33 extended rearward from the upper portions of the pair of sidewalls 32 with free ends thereof protruded towards each other. The bottom casing 50 has a retainer plate 51 at a front portion thereof and a backing plate 52 disposed in rear of the retainer plate 51. The retainer plate 51 defines a location hole 511 thereon. The backing plate 52 defines a substantially V-shaped guiding slot 521 at a top portion thereof and a receiving recess 522 communicated with a bottom of the guiding slot 521.

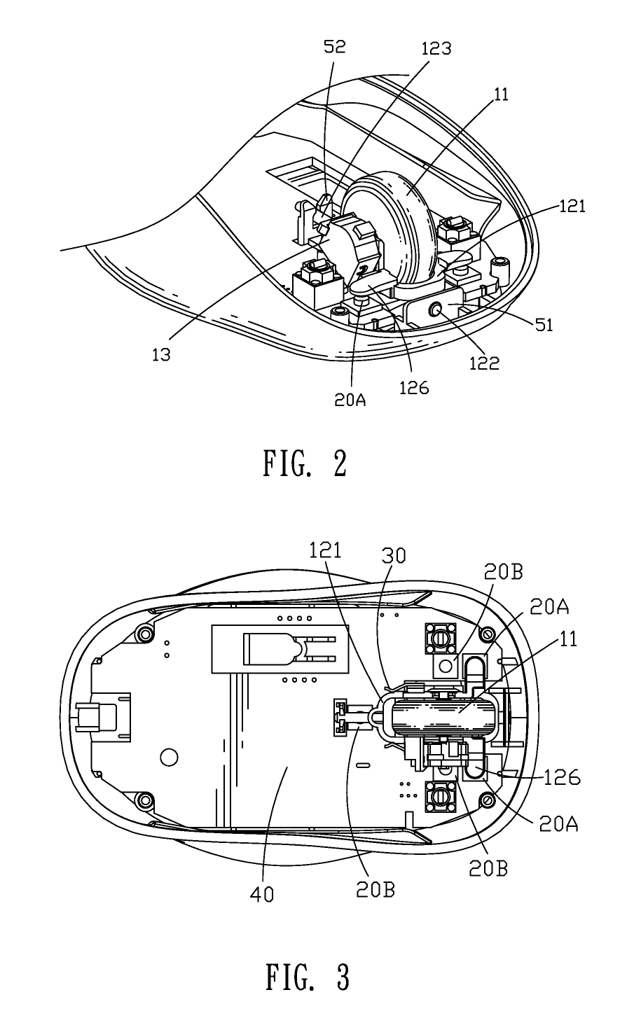

Referring to FIGS. 2 to 4, in assembly of the mouse 100, the PCB 40 is firstly assembled to the bottom casing 50 with the backing plate 52 passing through the slit 42 while the retainer plate 51 located in front of the opening 41. Then the latch element 30 is received in the opening 41 with the sidewalls 32 abutting against the rear edge 412 of the opening 41. Next, the roller unit 10 is installed to the bottom casing 50. The location post 122 of the roller bearing 12 is inserted into the location hole 511, the sliding post 123 slides into the receiving recess 522 along the guiding slot 521. In this case, the two elastic arms 33 of the latch element 30 are respectively abutting against the two opposite lateral sides of the frame 121, as best shown in FIG. 3. And meanwhile, the press wings 126 and the projection 129 are respectively positioned over the corresponding switches 20. Finally, the top casing 60 is coupled to the bottom casing 50 to enclose the roller unit 10, the PCB 40 and the latch element 30. The roller 11 partially projects out the top casing 60 from a through hole 61 (shown in FIG. 1) so that a user can operate it.

Referring to FIG. 1 and FIG. 3, when the roller 11 is located at a front position of the through hole 61, the press wings 126 and the projection 129 are respectively positioned over the corresponding front switches 20A. If a user presses down the roller 11, the projection 129 will press against and activate the corresponding front switch 20A located between the rear edge 412 of the opening 41 and the slit 42 to perform a middle click action. If the user stirs the roller 11 to tilt leftwards or rightwards, the left or right press wing 126 will press against and activate the corresponding front switch 20A located near the corresponding side edge 411 of the opening 41 to perform a leftward or rightward movement of a file or document or web page on display screen.

When the user stirs the roller 11 from the front position to a rear position of the through hole 61, the roller bearing 12 is brought to move rearward correspondingly. Simultaneously, the press wings 126 and the projection 129 are also moved rearward to position over the corresponding rear switches 20B. Because the front switches 20A and the rear switches 20B are the same structure, the mouse 100 can realize the same key functions as the roller 11 being located at the front position of the through hole 61 when the roller 11 is located at the rear position of the through hole 61.

As described above, compared with the current mouse, the roller 11 of the mouse 100 of the present invention is capable of being adjusted to the front position of the through hole 61 to make the press wings 126 and the projection 129 correspond to the three front switches 20A or adjusted to the rear position of the through hole 61 to make the press wings 126 and the projection 129 correspond to the three rear switches 20B. And moreover, no matter the roller 11 is adjusted to the front or the rear position of the through hole 61, the mouse 100 can realize the multi-button function by providing the pair of press wings 126 for pressing against and activating the corresponding switches 20 located near the two side edges 411 of the opening 41 to perform a leftward or rightward movement of a file or document or web page on display screen, and by providing the projection 129 for pressing against and activating the corresponding switches 20 located between the rear edge 412 of the opening 41 and slit 42 to perform a middle click action.

What is claimed is:

1. A mouse, comprising:
a bottom casing, the bottom casing having a retainer plate at a front portion thereof and a backing plate in rear of the retainer plate, the retainer plate defining a location hole thereon, the backing plate defining a receiving recess thereon;
a printed circuit board mounted on the bottom casing, the printed circuit board defining an opening penetrating a front side thereof to form two opposite side edges and a rear edge connected to the two side edges and a slit positioned in rear of the opening, the backing plate passing through the slit, the retainer plate located in front of the opening;
at least three switches two of which respectively located near the two side edges of the opening and the other one located between the rear edge of the opening and the slit;
a roller unit assembled to the bottom casing, the roller unit including a roller bearing, a roller pivotally assembled to the roller bearing, and an encoder fixed to the roller bearing and associated with the roller, the roller bearing having a location post extended forward from a front thereof to insert into the location hole of the retainer plate, and a sliding post extended rearward from a rear thereof to be received in the receiving recess of the backing plate, the roller bearing further having a pair of press wings extended outwardly from two opposite lateral sides thereof for corresponding to the two switches located near the two side edges of the opening, and a projection protruded from a bottom of the rear thereof for corresponding to the switch located between the rear edge of the opening and the slit; and
a top casing coupled with the bottom casing, the top casing defining a through hole thereon for allowing the roller to partially project out therefrom.

2. The mouse as claimed in claim 1, wherein the printed circuit board has six switches which are divided into three front switches and three rear switches respectively located near the three edges of the opening, the roller is capable of being adjusted to a front position of the through hole to make the press wings and the projection correspond to the three front switches or adjusted to a rear position of the through hole to make the press wings and the projection correspond to the three rear switches.

3. The mouse as claimed in claim 1, wherein the backing plate defines a substantially V-shaped guiding slot at a top portion thereof and communicated with the receiving recess for guiding the sliding post to slide into the receiving recess.

4. The mouse as claimed in claim 1, wherein the roller bearing has a substantially rectangular frame, the location post and the sliding post respectively extend from a front and a rear of the frame, the projection is protruded from a bottom of the rear of the frame, and the pair of press wings extend outwardly from front portions of two opposite lateral sides of the frame, the roller bearing further has a pair of support plates extended upwardly from middle portions of the two opposite lateral sides thereof, each support plate defines a pivot hole thereon, the roller has an axle pivotally engage with the pivot holes of the support plates.

5. The mouse as claimed in claim 1, further comprising a latch member located at the opening of the printed circuit board, the latch member has a pair of elastic arms respectively abutting against the two opposite lateral sides of the roller bearing.

6. The mouse as claimed in claim 6, wherein the latch member has a flat-plate base portion and a pair of sidewalls extended upwardly from both ends of the base portion to be against the rear edge of the opening, the pair of elastic arms extends rearward from the pair of sidewalls with free ends thereof protruded towards each other.
